(19) United States
(12) Patent Application Publication
(10) Pub. No.: US 2013/0113923 A1
(43) Pub. Date: May 9, 2013

(54) Blind Spot Detection Alert System

(71) Applicants: Chun-Liang Chien, Pingzhen City (TW); Chih-Woei Tsai, Tainan City (TW); Chih-Cheng Tu, Zhubei City (TW)

(72) Inventors: Chun-Liang Chien, Pingzhen City (TW); Chih-Woei Tsai, Tainan City (TW); Chih-Cheng Tu, Zhubei City (TW)

(73) Assignee: ALTEK AUTOTRONICS CORP., Hsinchu (TW)

(21) Appl. No.: 13/344,129

(22) Filed: Jan. 5, 2012

(30) Foreign Application Priority Data
Nov. 9, 2011 (TW) 100140949

(51) Int. Cl. H04N 7/18

(52) U.S. Cl. 348/135; 348/148; 348/E07.085

(57) ABSTRACT

A blind spot detection alert system. The system comprises two image capturing modules, a processing module, a first display module and a second display module. The two image capturing modules capture a right image and a left image respectively. The first display module is disposed on the right of the second display module. The processing module receives the right image and the left image to analyze a car moving direction. When the processing module determines the car moving direction is a right direction, the first display module displays the right image. When the processing module determines the car moving direction is a left direction, the second display module displays the left image. The processing module calculates a distance to a coming car, a moving direction of the coming car and a speed of the coming car according to the image to get an alert message.

### CROSS-REFERENCE TO RELATED APPLICATION

This application claims the benefit of priority to Taiwan Patent Application No. 100140949, filed on Nov. 9, 2011, in the Taiwan Intellectual Property Office, the disclosure of which is incorporated herein in its entirety by reference.

### BACKGROUND OF THE INVENTION

1. Field of the Invention

The present invention relates to a detection alert system, in particular to the blind spot alert detection system capable of detecting the behavior and the intention of a driver and observing an approaching car in a blind spot area to dynamically adjust the sensitivity and computing resource for blind spot detection.

2. Description of the Related Art

Generally speaking, when driving, a driver cannot pay attention to a blind spot area in the sideward direction and backward direction due to the structure of a vehicle body, even though the driver has used a large or wide-angle side mirror. Therefore, a detection system for a blind spot is very important to driving safety and could prevent car accidents. As science and technology advance, a center console of various models of cars generally comes with a screen for displaying a car approaching from behind or a position of an obstacle detected by radar. However, when the drivers drive the car to the left side, most drivers usually look at the left-side mirror to determine whether there is an obstacle in the blind spot area or not, but the screen on the center console cannot provide immediate information to the drivers to assure driver safety, which causing inconvenience to the drivers.

Currently, a conventional blind spot detection system can detect an approaching object in the blind spot, which warns the drivers that an object is coming from a particular direction by a light signal or a warning sound effect. However, the driver would not be warned of the approaching object in the blind spot area through the warning effect and the distance between the approaching object in the blind spot area and the vehicle. As a result, a comprehensive protection cannot be provided during driving, particularly when an approaching car is situated within a blind spot area.

Obviously, it is an urgent issue for designers and manufacturers to design and develop a blind spot detection alert system capable of detecting the behavior and the intention of drivers during driving, allowing drivers to be at the sight of an approaching car, and dynamically adjusting the sensitivity and computing resource.

### SUMMARY OF THE INVENTION

In view of the aforementioned problem of the prior art, a primary objective of the present invention is to provide a blind spot detection alert system to overcome the problem of unable to detect or sense the driver's behavior or intention, and pay attention to an approaching object in the blind spot.

To achieve the aforementioned objective, the present invention provides a blind spot detection alert system, comprising two image capturing modules, a processing module, a first display module and a second display module. The two image capturing modules capture a right image and a left image respectively. The first display module is installed on the right side of second display module. The processing module receives the right image and the left image to perform an image processing and analyze a car moving direction. If the car moving direction is determined to be right, the processing module would display the right dynamic image at the first display module; and if the car moving direction is determined to be a left direction, the processing module would display the left dynamic image at the second display module.

To achieve the aforementioned objective, the present invention further provides a blind spot detection alert system, comprising an image capturing module, a processing module and a head-up display module. The image capturing module captures a right image or a left image. The processing module calculates a vehicle distance, a vehicle direction or a vehicle speed and sets a safety range according to the right image or left image, and compares the vehicle distance, vehicle direction or vehicle speed with the safety range to analyze an alert message. The head-up display module is provided for displaying an object pattern, a vehicle distance, a vehicle direction, a vehicle speed or an alert message.

To achieve the aforementioned objective, the present invention further provides a blind spot detection alert system, comprising an image capturing module, and a processing module. The image capturing module captures a right image or a left image. The processing module analyzes the right image and the left image to obtain a car moving direction and dynamically adjusts the computing resource, the screening threshold of the false alarm, the screen resolution or the frame rate used for processing the right image and the left image according to the car moving direction.

In summation of the description above, the blind spot detection alert system of the present invention detects the behavior or intention of a driver to obtain the distance, direction or speed of an approaching object in a blind spot directly from the first display module, the second display module or the head-up display module. The distance, direction or speed of the approaching object could be used as a basis for dynamic adjustment of an algorithm and to dynamically adjust the sensitivity of the dynamic adjusting system, allocate the computation resources and reduce the information error rate effectively.

In the meantime, the first display module and the second display module could be used for dividing or classifying the dynamic image to facilitate drivers to know an approaching car or object in a blind spot conveniently and effectively.

The technical characteristics of the present invention will become clear with the detailed description of the preferred embodiments accompanied with the illustration of related drawings as follows. It is noteworthy to point out that same numerals are used for representing respective elements in the description of the following preferred embodiments.

### BRIEF DESCRIPTION OF THE DRAWINGS

FIG. 1 is a block diagram of a blind spot detection alert system in accordance with a first preferred embodiment of the present invention;

FIG. 2 is a first schematic view of a blind spot detection alert system in accordance with the first preferred embodiment of the present invention;

FIG. 3 is a second schematic view of a blind spot detection alert system in accordance with the first preferred embodiment of the present invention;

FIG. 4 is a flow chart of a processing method of a blind spot detection alert system in accordance with the first preferred embodiment of the present invention;

FIG. 5 is a block diagram of a blind spot detection alert system in accordance with a second preferred embodiment of the present invention;

FIG. 6 is a first schematic view of a blind spot detection alert system in accordance with the second preferred embodiment of the present invention;

FIG. 7 is a second schematic view of a blind spot detection alert system in accordance with the second preferred embodiment of the present invention; and

FIG. 8 is a flow chart of a processing method of a blind spot detection alert system in accordance with the second preferred embodiment of the present invention.

### DETAILED DESCRIPTION OF THE PREFERRED EMBODIMENTS

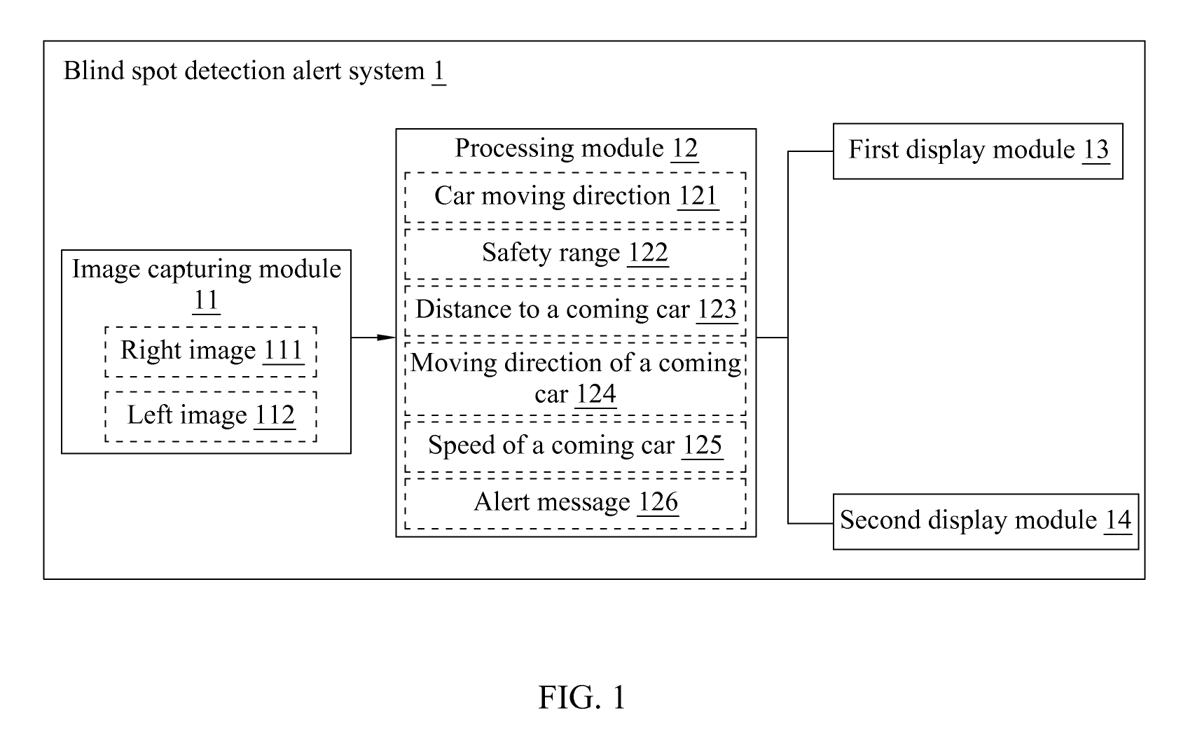

With reference to FIG. 1 for a block diagram of a blind spot detection alert system in accordance with the first preferred embodiment of the present invention, the blind spot detection alert system 1 comprises an image capturing module 11, a processing module 12, a first display module 13 and a second display module 14. Preferably, the blind spot detection alert system 1 of the present invention is installed at a car, such that a driver can definitely recognize an object approaching the blind spot, and the actual distance, direction or speed of the approaching object, and then the driver can keep distance from the approaching object. The image capturing module 11 may be a photo sensitive element such as a complementary metal oxide semiconductor (CMOS) or a charge coupled device (CCD), a lens and a lens module. The processing module 12 is electrically coupled to the image capturing module 11, and the processing module 12 may be a central processing unit (CPU) or a micro processing unit. The first display module 13 and the second display module 14 may be liquid crystal displays (LCD) or touch LCD screens.

The image capturing module 11 of the blind spot detection alert system 1 of the present invention can capture a right image 111 and a left image 112 respectively. A driver's behavior and intention can be analyzed by the processing module 12 according to the turning information that the driver turns a steering wheel or the direction light information that the user switches on a direction light by the driver, which indicates the desired moving direction of the driver. The processing module 12 can analyze a car moving direction 121 according to the right image 111 or the left image 112 and then calculate the distance to a coming car 123, the direction of the coming car 124 and the speed of the coming car 125. In the meantime, the processing module 12 can set a safety range 122, which compared with the distance to the coming car 123, the direction of the coming car 124 and the speed of the coming car 125 to determine issuing a warning signal 126. If the car moving direction 121 is determined to be right, the processing module 12 will display the right image 111 at the first display module 13. If the car moving direction 121 is determined to be left, the processing module 12 will display the left image 112 on the second display module 14. Preferably, the first and second display module 13, 14 are installed on a center console or a dashboard in the car respectively. In this embodiment, a left-hand drive is used as an example for illustrating the present invention, but the invention is not limited to such arrangement only.

On the other hand, if the driver wants to move to a right lane or make a right turn, the driver can look at the first display module 13 on the center console. If the driver wants to move to the left lane or make a left turn, the driver can look at the second display module 14 on dashboard. Therefore, a car approaching a blind spot area could be observed by the driver and keep the driver safe. In addition, the processing module 12 of the blind spot detection alert system 1 could dynamically adjust a computing resource, a screening threshold of a false alarm, a screen resolution or a frame rate of the moving direction according to the turning information or the direction light information.

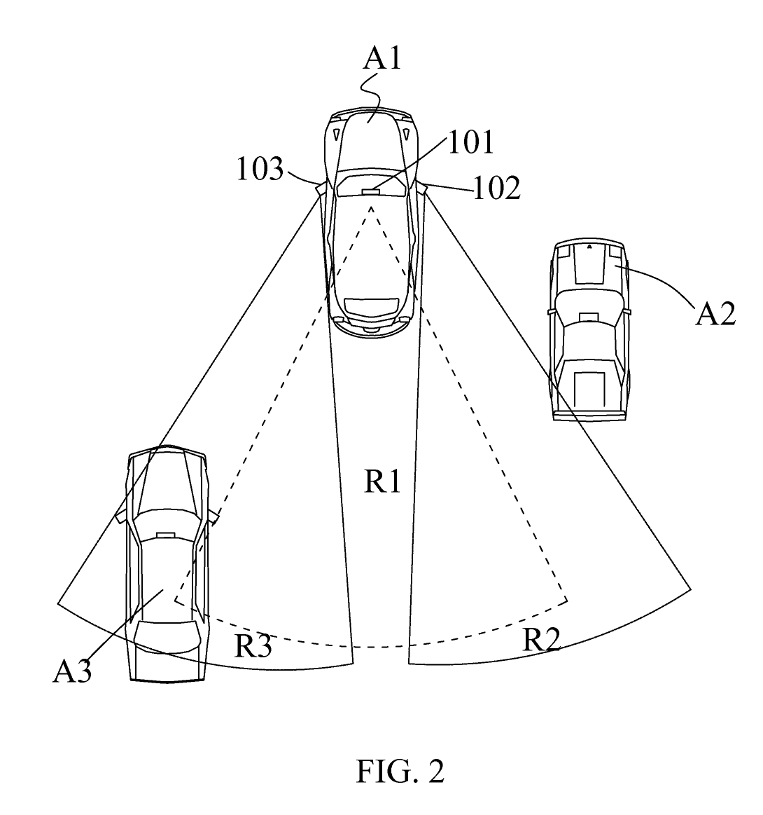

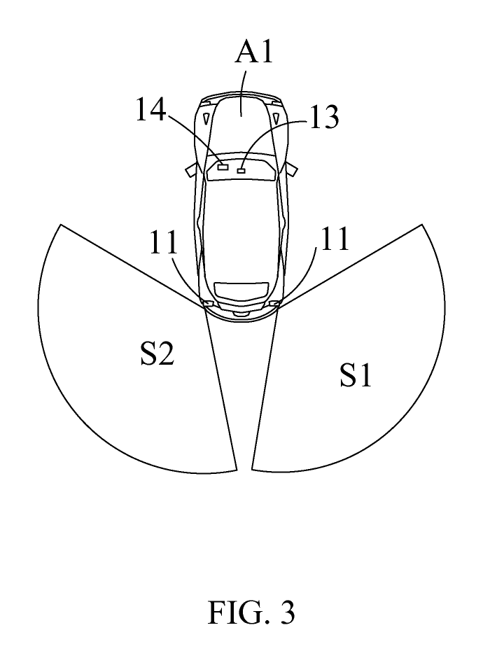

With reference to FIGS. 2 and 3 for first and second schematic views of a blind spot detection alert system in accordance with the first preferred embodiment of the present invention respectively. Generally speaking, installed inside the car A1 are the review mirror whose view angle is R1, the right-side mirror whose view angle is R2 and the left-side mirror whose view angle is R3. To make it easy to understand the technical characteristics of the present invention, view angles R1, R2 and R3 indicated in the figures show the view angle range, but the invention is not limited to such arrangements only. In FIG. 2, a driver in the car A1 can view a car A3 from the left-side mirror 103, but cannot view a car A2 from the right-side mirror 102. Thus, the blind spot detection alert system of the present invention can be used for capturing dynamic images by the image capturing module.

In FIG. 3, the car A1 has a first display module 13 installed on the center console. If the car moving direction is determined to right, a right image will be displayed by the first display module 13. A second display module 14 could be installed on the dashboard of the car A1. If the car moving direction is determined to left, a left image will be displayed by the second display module 14. In this preferred embodiment, two image capturing modules 11 are installed on a rear bumper of the car A1 to further illustrate the technical characteristics of the present invention, and the quantity and installation position of the image capturing modules 11 could be changed according to requirements. For example, the image capturing module 11 could be installed under one of the left-side mirror and right-side mirror, or on both sides of a front bumper, and the quantity of the image capturing modules could be 2, 4, or 6. The installation positions or the quantity of the image capturing modules of the present invention are not intended for limiting the scope of the present invention. In FIG. 3, the view angle range of the right-side image capturing module 11 is S1, and the view angle range of the left-side image capturing module 11 is S2. S1 and S2 in the FIG. 3 show the view angle ranges of the image capturing module 11 for illustrating the technical characteristics of the present invention, but not intended for limiting the scope of the present invention.

For example, when the driver turns the steering wheel counterclockwise or switches on a left direction light which means that the driver wants to make a left turn or move to the left lane, the processing module of the present invention can capture turning information or direction light information from the steering wheel and then analyze the moving direction of the driver. The processing module analyzes the moving direction of the driver, so that a right image and a left image could be captured by the image capturing module 11 according to the moving direction. Therefore, the processing module can further analyze the car moving direction according to the right image or left image and calculate the distance, the direction and the speed of a right-side coming car, or which of a left-side coming car. It is noteworthy to point out that the first display module 13 installed on a center console inside a car could show the right image, and the processing module compares the distance, direction and speed of the right-side coming car with the safety range to determine issuing an alert message. The second display module 14 installed on a driver dashboard of the car A1 could display a left image, and the processing module compares the distance, direction and speed of the left-side coming car with the safety range to determine issuing an alert message.

In this way, if the driver wants to make a left turn or move to the left lane, the information about a car coming from the left side could be observed by the driver from second display module 14 the on the dashboard, and a more convenient application of the blind spot detection and warning function could be achieved.

It is noteworthy to point out, when the driver turns the steering wheel counterclockwise, the blind spot detection alert system of the present invention determine the behavior and intention that the user wants to turn left or move to the left lane. Thus, the processing module could dynamically adjust the computing resource of the system to configure the system to concentrate on the calculation of the left side and reduce the hardware requirements of the system and improve the sensitivity of the system. Besides, the left-side detection range is extended from 20 meters to 50 meters. In general, the capturing module can capture images with an image resolution of 640*480 pixels while the car is moving, and the speed for the processing module to analyze the image is approximately equal to 30 frames per second. If the driver drives the car on a safer road, the required resolution could be reduced to 320*240 pixels. However, if the driver is driving on a much more dangerous environment, the processing module could dynamically adjust the resolution of the image captured by the image capturing module or increase the number of the images that the processing module can process in each second.

In the meantime, the blind spot detection usually detects a black shadow or an approaching optical flow to determine issuing an alert message. However, if the driver turns the steering wheel or switches on the direction light, the processing module will dynamically adjust an algorithm or adopt an optimal information processing technique such as neural network or pattern recognition.

It is noteworthy to point out that the blind spot detection alert system of this preferred embodiment further comprises a plurality of head-up display modules, and the processing module can recognize the size of at least one object in the images and convert the object into a object pattern, and the head-up display module is provided for displaying the object pattern, distance to the coming car, direction of the coming car, speed of the coming car or alert message. The processing module can also recognize the size of the object and then search a corresponding pattern from the system to act as the object pattern.

Even though the concept of the processing method of the blind spot detection alert system of the present invention has been described in the aforementioned section of the present invention, a flow chart is provided for clearly illustrating the present invention as follows.

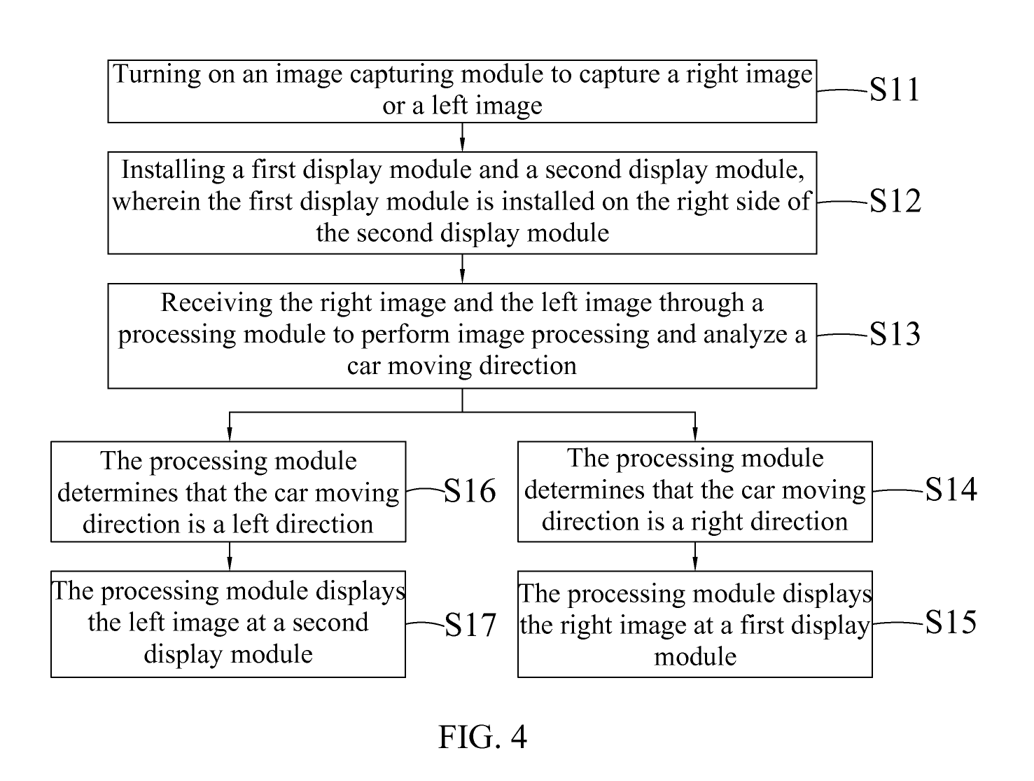

With reference to FIG. 4 for a flow chart of a processing method of a blind spot detection alert system in accordance with the first preferred embodiment of the present invention, the processing method of the present invention is applicable for a blind spot detection alert system, and the blind spot detection alert system comprises an image capturing module, a processing module, a first display module and a second display module. The processing method of the blind spot detection alert system of the present invention comprises the following steps:

S11: Turning on an image capturing module to capture a right image or a left image.

S12: Installing a first display module and a second display module, wherein the first display module is installed on the right side of the second display module.

S13: Receiving the right image and the left image through a processing module to perform image processing and analyze a car moving direction.

S14: Carrying out the step S15 to display the right image at a first display module by the processing module after the car moving direction is determined to be the right.

S16: Carrying out the step S17 to display the left image at a second display module by the processing module after the car moving direction is determined to be the left.

The detailed description and implementation of the processing method of the blind spot detection alert system in accordance with the present invention have been described in the section of the blind spot detection alert system of the invention, and thus will not be described again.

Based on the first preferred embodiment, the present invention further provides a second preferred embodiment for illustrating the present invention.

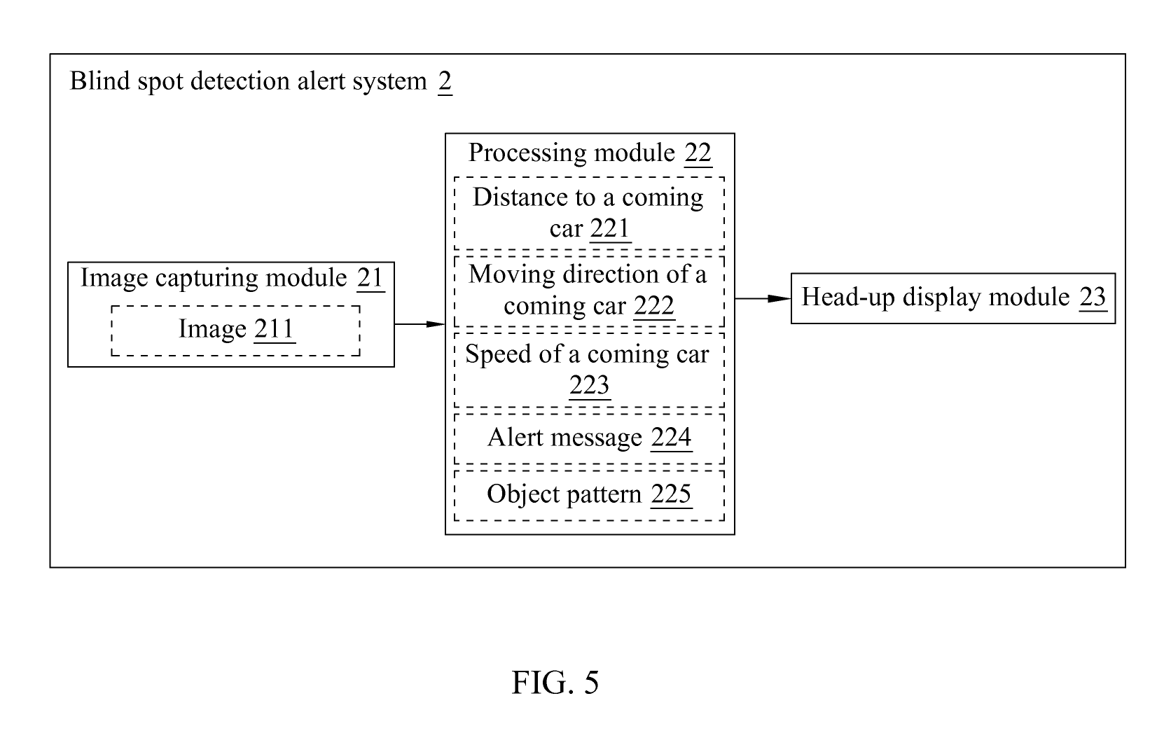

With reference to FIG. 5 for a block diagram of a blind spot detection alert system in accordance with a second preferred embodiment of the present invention, the blind spot detection alert system 2 comprises an image capturing module 21, a processing module 22 and a head-up display module 23. The blind spot detection alert system 2 of the present invention is preferably installed in a car, such that can observe the actual distance to an approaching car though the head-up display module 23, and keep a distance. The image capturing module 21 may be a photo sensitive element such as a complementary metal oxide semiconductor (CMOS) or a charge coupled device (CCD), a lens and a lens module, etc. The processing module 22 is electrically coupled to the image capturing module 21, and the processing module 22 may be a central processing unit (CPU) or a micro processing unit. The head-up display module 23 may be a head-up display installed at a left-front side and a right-front side of the dashboard to facilitate drivers to pay attention to the information displayed on the head-up display module 23 effectively while viewing a review mirror and a left-side mirror.

The image capturing module 21 of the blind spot detection alert system 2 in accordance with the present invention can capture an image 211. The processing module 22 can detect the behavior and intention of the driver according to the turning information that the driver turns a steering wheel or direction light information that the driver switches a direction light, indicating the desired moving direction during driving. The processing module 22 can calculate a distance to a coming car 221, a moving direction of the coming car 222 or a speed of the coming car 223 according to the image 211. In the meantime, the processing module 22 can set a safety range, which compared with the distance to the coming car 221, the moving direction of the coming car 222 and the speed of the coming car 223 to determine issuing a warning signal 224. The processing module 22 can recognize the size of at least one object in the image 211 and convert the object into a object pattern 225, and the head-up display module 23 is provided for displaying the object pattern 225, the distance to the coming car 221, the moving direction of the coming car 222, the speed of the coming car 223 or alert message 224. After recognizing the size of the object, the processing module 22 can search a corresponding pattern in the system to act as the object pattern 225.

In this preferred embodiment, it is noteworthy to point out that the blind spot detection alert system 2 further comprises a first display module and a second display module, and the processing module 22 can detect the behavior and intention of the driver according to the turning information of a steering wheel or direction light information while switching a direction light by the driver, indicating the desired moving direction during driving. The processing module 22 can perform an analysis based on the desired car moving direction of the driver. If the car moving direction is determined to be the right direction, the right image will be displayed by the processing module 22 on the first display module. And if the car moving direction is determined to be a left direction, the left image will be displayed by the processing module 22 on the second display module. Preferably, the first and second display modules are installed on the center console or a dashboard in the car respectively.

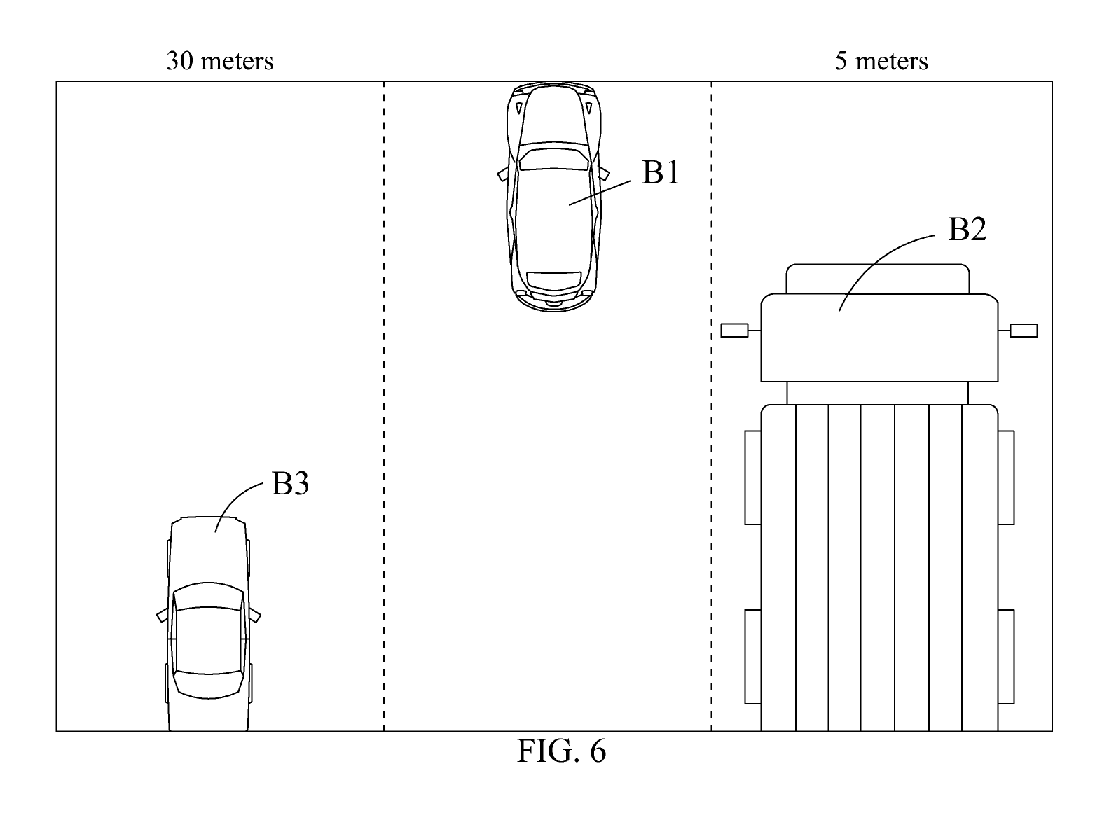

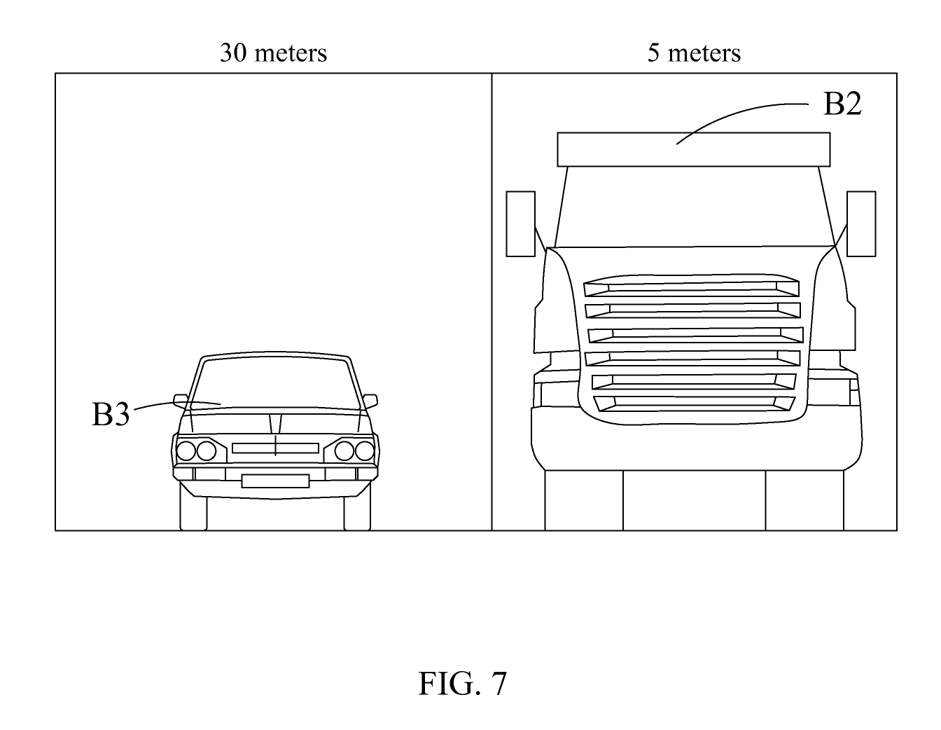

With reference to FIGS. 6 and 7 for first and second schematic views of a blind spot detection alert system in accordance with the second preferred embodiment of the present invention respectively, a head-up display module shows a pattern. The processing module of the blind spot detection alert system of the present invention can dynamically adjust a computing resource, a screening threshold of a false alarm, a screen resolution or a frame rate of the moving direction according to the turning information or direction light information from the steering wheel. If the driver wants to move to another lane or make a turn, the driver can use the image capturing module of the blind spot detection system to capture an image, such that the processing module converts the image into an object pattern according to the size of an object in the image. Therefore, the head-up display module can display the object pattern which includes a truck B2 and a car B3, so that the driver can know from the head-up display module about the actual distance between the car B1 and a vehicle (the truck B2 or the car B3) approaching the blind spot. In the figure, the distance between the truck B2 and the car B1 is equal to 5 meters, and the distance between the car B3 and the car B1 is equal to 30 meters. It is noteworthy to point out that the head-up display modules of the present invention are preferably installed on the left-front side and the right-front side of the dashboard, but the quantity and installation positions of the head-up display modules are not limited to the aforementioned arrangements only, and they can be changed as required.

For example, if the driver turns the steering wheel counterclockwise, the blind spot detection alert system of the present invention determine the behavior and the intention that the driver wants to turn left or move to the left lane. Thus, the processing module could dynamically adjust a computing resource of the system to configure the system concentrate on the calculation of the left side, reduce the hardware requirements of the system and improve the sensitivity of the system. Besides, the left-side detection ranges are extended from 20 meters to 50 meters. In general, the capturing module can capture images with an image resolution of 640*480 pixels while the car is moving, and the speed for analyzing images by the processing module is approximately equal to 30 frames per second. If the driver drives the car on a safer road, the required resolution could be reduced to 320*240 pixels. However, if the driver is driving on a much more dangerous environment, the processing module may dynamically adjust the resolution of the image captured by the image capturing module or increase the number of the images that the processing module can process every second.

In the meantime, the blind spot detection usually detects a black shadow or an approaching optical flow to determine issuing an alert message. However, if the driver turns the steering wheel or switches on the direction light, the processing module will dynamically adjust an algorithm or adopt an optimal information processing technique such as neural network or pattern recognition.

Additionally, it is noteworthy to point out that the blind spot detection alert system of the present invention can use the processing module to calculate the distance to a coming car, the moving direction of the coming car or the speed of the coming car in the blind spot area according to the image captured by the image capturing module, and can use the head-up display to display information of the car approaching the blind spot area. The processing module can recognize a dynamic object in the image such as a car B3, a man, a dog, a bicycle, a truck B2, or any dynamic object that may show up near the car B1. Therefore, the processing module can recognize the size of the object in the image and convert the object into a corresponding object pattern. In other words, if the object of the dynamic image includes the truck B2 and the car B3, then the images of truck B2 and the car B3 will be converted into a corresponding object pattern of the truck B2 and the car B3 by the processing module.

Further, the object pattern shown by the head-up display module may be an aerial view or a front pattern of a car of the object, but the displayed screen is not limited to the aforementioned patterns only. In addition, the head-up display module may further display the distance to the coming car, moving direction of the coming car, speed of the coming car or alert message to remind the driver to pay more attention to the object approaching the blind spot area.

Even though the concept of the processing method of the blind spot detection alert system of the present invention has been described in the aforementioned section of the present invention, a flow chart is provided for clearly illustrating the invention as follows.

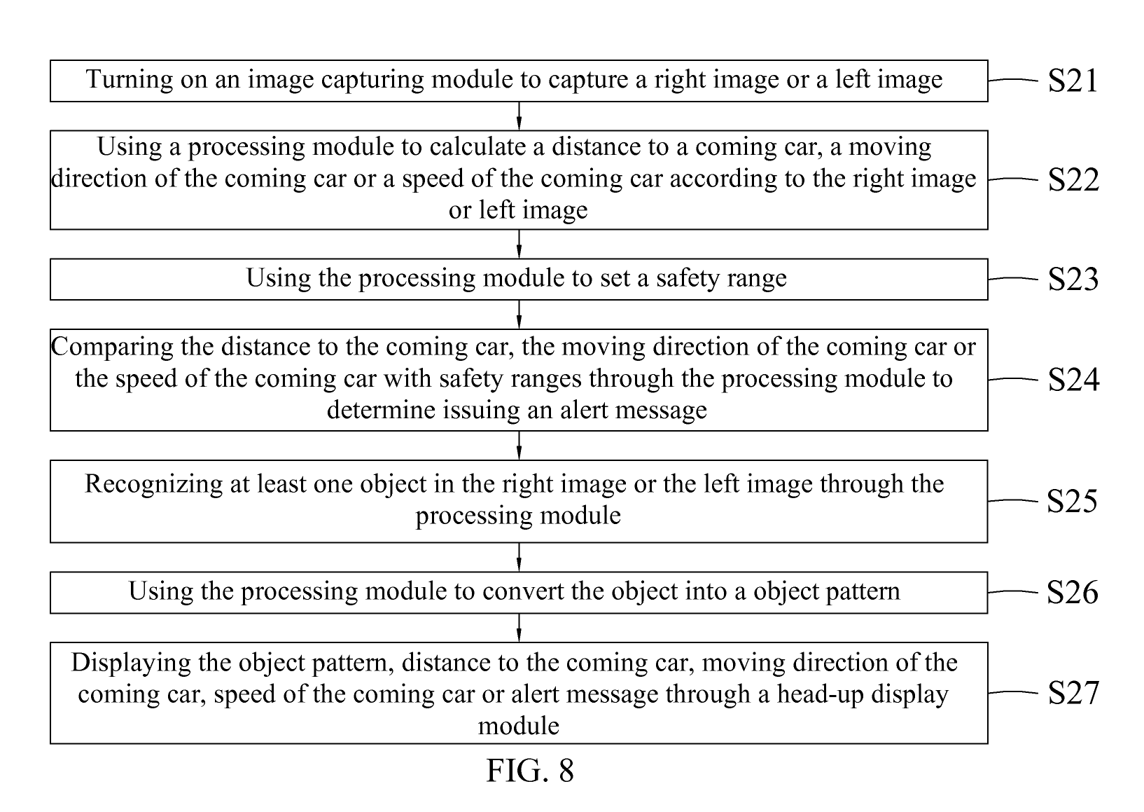

With reference to FIG. 8 for a flow chart of a processing method of a blind spot detection alert system in accordance with the second preferred embodiment of the present invention, the processing method of the present invention is applicable for a blind spot detection alert system, and the blind spot detection alert system comprises an image capturing module, a processing module and a head-up display module. The processing method of the blind spot detection alert system in accordance with the present invention comprises the following steps:

S21: Turning on an image capturing module to capture a right image or a left image.

S22: Using a processing module to calculate the distance to a coming car, the moving direction of the coming car or the speed of the coming car according to the right image or left image.

S23: Using the processing module to set a safety range.

S24: Comparing the distance to the coming car, the moving direction of the coming car or the speed of the coming car with safety ranges through the processing module to determine issuing an alert message.

S25: Recognizing at least one object in the right image or the left image through the processing module.

S26: Using the processing module to convert the object into an object pattern.

S27: Displaying the object pattern, the distance to the coming car, the moving direction of the coming car, the speed of the coming car or alert message through a head-up display module.

The processing method of the blind spot detection alert system of the present invention has been described in the section of the blind spot detection alert system of the present invention already, and thus will not be described again.

In summation of the description above, the blind spot detection alert system of the present invention has one or more of the following advantages:

(1) The blind spot detection alert system of the present invention can detect the behavior or intention of a driver, and recognize the distance, direction or speed of an approaching object in the blind spot directly from the first display module, the second display module or the head-up display module.

(2) The blind spot detection alert system of the present invention can divide or classify the dynamic image by using the first display module and the second display module, and facilitate a driver to view an approaching object in the blind spot effectively.

(3) The blind spot detection alert system of the present invention can detect the behavior or intention of a driver as a basis for effectively dynamically adjusting the sensitivity of the system, allocate the computation resources, and reducing the information error rate.

While the invention has been described by means of specific embodiments, numerous modifications and variations could be made thereto by those skilled in the art without departing from the scope and spirit of the invention set forth in the claims.

What is claimed is:

1. A blind spot detection alert system, comprising:
two image capturing modules, capturing a right image and a left image respectively;
a first display module and a second display module, wherein the first display module is installed on the right side of the second display module; and
a processing module, receiving the right image and the left image to perform an image processing to analyze a car moving direction, such that when the car moving direction is determined to be right, the right image is displayed by the processing module at the first display module; and when the car moving direction is determined to be left, the left image is displayed by the processing module at the second display module.

2. The blind spot detection alert system of claim 1, wherein the processing module calculates a distance to a coming car, a moving direction of the coming car or a speed of the coming car, and compare the distance to the coming car, the moving direction of the coming car or the speed of the coming car with a safety range to determine issuing an alert message; wherein the safety range is determined by the processing module range according to the right image or the left image.

3. The blind spot detection alert system of claim 1, further comprising at least one head-up display module for displaying an object pattern, a distance to a coming car, a moving direction of the coming car, a speed of the coming car or an alert message.

4. The blind spot detection alert system of claim 3, wherein the processing module recognizes at least one object in the right image or the left image, and converts the at least one object into the object pattern, and the object pattern is displayed by the head-up display module.

5. The blind spot detection alert system of claim 1, wherein the processing module analyzes the car moving direction according to a turning information or a direction light information of a steering wheel.

6. The blind spot detection alert system of claim 5, wherein the processing module detects a black shadow or an approaching optical flow according to the turning information or the direction light information, so as to determine an alert message.

7. The blind spot detection alert system of claim 5, wherein the processing module dynamically adjusts a computing resource, a screening threshold of a false alarm, a screen resolution or a frame rate used for processing the right image and the left image according to the car moving direction.

8. A blind spot detection alert system, comprising:
an image capturing module, capturing a right image or a left image;
a processing module, calculating a distance to a coming car, a moving direction of the coming car or a speed of the coming car according to the right image or the left image, and setting a safety range, and comparing the distance to the coming car, the moving direction of the coming car or the speed of the coming car with the safety range to determine an alert message; and
a head-up display module, displaying the distance to the coming car, the moving direction of the coming car, the speed of the coming car or the alert message.

9. The blind spot detection alert system of claim 8, wherein the processing module recognizes at least one object in the right image or the left image, and converts the at least one object into an object pattern, and the object pattern is displayed by the head-up display module.

10. The blind spot detection alert system of claim 8, wherein the processing module determines the car moving direction according to a turning information or a direction light information of a steering wheel.

11. The blind spot detection alert system of claim 10, wherein the processing module dynamically adjusts a computing resource, a screening threshold of a false alarm, a screen resolution or a frame rate of the car moving direction according to the car moving direction.

12. The blind spot detection alert system of claim 8, further comprising a first display module for displaying the right image.

13. The blind spot detection alert system of claim 8, further comprising a first display module and a second display module, and the first display module being installed on the right side of the second display module, and the right image being displayed by the first display module, and the left image being displayed by the second display module.

14. A blind spot detection alert system, comprising:
two image capturing module, capturing a right image and a left image; and
a processing module, processing the right image and the left image, and dynamically adjusting a computing resource, a screening threshold of a false alarm, a screen resolution or a frame rate used for processing the right image and the left image according to a car moving direction.

15. The blind spot detection alert system of claim 14, further comprising a display module for displaying the right image or the left image.

16. The blind spot detection alert system of claim 14, wherein the processing module calculates a distance to a coming car, a moving direction of the coming car or a speed of the coming car and sets a safety range according to the right image and the left image, and the distance to the coming car, the moving direction of the coming car or the speed of the coming car are compared with the safety range to determine an alert message.

17. The blind spot detection alert system of claim 14, wherein the processing module recognizes at least one object in the right image or the left image, and converts the at least one object into an object pattern, and the blind spot detection alert system further comprises at least one head-up display module for displaying the object pattern and a distance to a coming car, a moving direction of the coming car, a speed of the coming car or an alert message calculated by the processing module.
